(19) United States
(12) Patent Application Publication
(10) Pub. No.: US 2016/0214117 A1
(43) Pub. Date: Jul. 28, 2016

(54) MAGNETIC FILTRATION APPARATUS

(71) Applicant: ECLIPSE MAGNETICS LIMITED, South Yorkshire (GB)

(72) Inventors: Keith JACKSON, South Yorkshire (GB); Gary LIPTROT, South Yorkshire (GB)

(21) Appl. No.: 14/917,222

(22) PCT Filed: Sep. 10, 2014
(86) PCT No.: PCT/GB2014/052733

§ 371 Date: Mar. 7, 2016

(30) Foreign Application Priority Data
Sep. 11, 2013 (GB) 1316189.8

(51) Int. Cl. B03C 1/033; B03C 1/28

(52) U.S. Cl. CPC B03C 1/0332; B03C 1/286; B03C 2201/18; B03C 2201/28

(57) ABSTRACT

A magnetic filtration apparatus to separate magnet susceptible contaminant material from a working fluid. The apparatus comprises a housing having an internal chamber divided into a plurality of sub-chambers of different internal volume to change the fluid flow speed through the device and optimise filtration performance A plurality of elongate magnetic cores are mounted at a cartridge assembly to allow convenient and rapid interchange of magnetic cores at the same or different configurations.

### FIELD OF INVENTION

The present invention relates to magnetic filtration apparatus configured to separate contaminant material from a working fluid and in particular, although not exclusively, to filtration apparatus having a plurality of separation chambers, with each chamber having a magnetic core to entrap the contaminant material that may be conveniently inserted and removed manually at the respective chamber.

### BACKGROUND ART

Industrial applications that utilise a working fluid to provide cooling, lubrication or to remove wear debris from machine processing tools and products, employ fluid filtration devices to extract particulate matter from the fluid. The cleaned fluid may then be re-circulated for further use or more readily disposed of due to the removal of the particulate matter. Without filtration devices, the working fluid would quickly become heavily contaminated resulting in machine wear and/or failure. Also, in most territories, the filtering and cleaning of industrial fluid waste is required prior to discarding.

A number of magnetic based filtration devices have been proposed, configured to filter magnetic particles from fluids in particular, liquids. Such units may be employed in an on-line capacity, forming part of the fluid circuit during operation of the machinery or production line, or in an off-line state in which the working fluid is diverted or isolated from the production line when inoperative to provide the required filtration.

GB 1192870, US 2007/0090055 and WO 2005/061390 disclose cartridge based magnetic separators. Fluid, flowing through the cartridge passes over a magnet which entraps the ferrous particles within its magnetic field. Clean, filtered liquid then flows out of the cartridge. GB 2459289 discloses magnetic filtration apparatus that utilises a carousel assembly mounting a plurality of filter cartridges between operative filtration positions and at least one cleaning position. An automated cleaning mechanism is provided to dislodge deposited ferrous material from entrapment by the magnetic field as part of the filtration cycle. The removal of deposited contaminant material is a necessity to avoid saturation of the filter and ultimately blockage of the fluid flow path and termination of the working fluid flow cycle which in turn would terminate the manufacturing process being reliant upon the working fluid.

US 2004/0182769; WO 2009/137710; US 2008/0073268; U.S. Pat. No. 5,089,129; U.S. Pat. No. 4,251,372 and U.S. Pat. No. 4,519,906 disclose further filtration devices to remove contaminant particulate from a primary working fluid.

However, conventional magnetic filtering devices are typically restricted to a particular configuration of magnetic body or core that forms an integral part of the assembly. That is, existing devices are typically adapted for a single filtration configuration such that if the strength of the core or the configuration of the cores is unsuitable for a particular application, the entire unit must be replaced. Additionally, a large percentage of existing devices are automated or semi-automated in that cleaning or purging operations occur automatically. This is a further disadvantage as it inhibits the option for personnel to adapt or change the configuration of the magnetic filter to better suit new or slightly different filtering requirements. What is required is a magnetic filtration device that addresses the above problems.

### SUMMARY OF THE INVENTION

It is an objective of the present invention to provide a magnetic filtration device that is effective to filter magnetically susceptible material via a multi chamber configuration that allows manual removal and insertion of magnetic cores that, in turn, provides for the interchange of different cores and/and different configurations of magnetic elements to provide a magnetic filtration device that is adaptable to suit a variety of different filtration requirements.

The objectives are achieved by providing filtration apparatus to accommodate a plurality of magnetic cores within a housing body where the magnetic cores are assembled and secured to a common cartridge that may be readily inserted and removed at the housing body manually. In particular, the housing body is formed with an open end such that a movable lid is adapted to be moved between an open position, that allows access to the internal chambers within the housing body and a closed position, to contain the magnetic cores within the internal chambers. The multiple chamber and cartridge based core arrangement provides the convenient and rapid interchange of different magnetic core configurations. In particular, the present cartridge based configuration in which multiple magnet cores are attached to a single, common base (or head unit) is advantageous as the magnetic characterises can be varied and interchanged conveniently including in particular: different numbers and positions of magnetic cores; magnetic cores of different magnetic strength and/or magnetic cores that create different magnetic field circuit shape and configurations to change the magnitude and/or shape and size of the entrapment zone as the magnetically susceptible materials flow through the housing body.

The present apparatus comprises a multi-chamber housing in which internal fluid flow is directed along at least two flow paths through the device, each flow path passing over the full length of an elongate magnetic core according to a pre-filtration and a final filtration treatment. The apparatus also provides a change in the rate of flow through the different sub-channels (or chambers) to optimise filtration efficiency. Finally, the present filter comprises a simplified construction to reduce the number of sealing gaskets, o-rings and the like so as to minimise maintenance and greatly facilitate efficient cleaning and repair as required.

According to a first aspect of the present invention there is provided magnetic filtration apparatus to separate contaminant material from a fluid, said apparatus comprising: a housing to provide containment of a fluid flowing through the apparatus, the housing having a fluid inlet and a fluid outlet; a first elongate chamber within the housing, the first chamber in fluid communication with the inlet substantially towards a first end to allow fluid to enter the first chamber; a first elongate magnetic core extending axially within the first elongate chamber such that a magnetic field generated by the first magnetic core is created in the fluid flow path to entrap contaminant material as it flows passed the first magnetic core; a second elongate chamber within the housing, the second chamber in fluid communication with the outlet substantially towards a first end to allow the fluid to exit the second chamber, wherein the volume of the first chamber is less than the volume of the second chamber such that a fluid flow speed in the first chamber is greater than a fluid flow speed in the second chamber; a second elongate magnetic core extending axially within the second elongate chamber such that a magnetic field generated by the second magnetic core is created in the fluid flow path to entrap contaminant material as it flows passed the second magnetic core; a passageway connecting the first and second elongate chambers in internal fluid communication towards their respective second ends such that the fluid is directed to flow from the inlet passed substantially the full length of the first magnetic core in a first direction, through the passageway, passed substantially the full length of the second magnetic core in a second direction opposed to the first direction to the outlet; wherein the housing comprises an open end to allow the first and second cores to be removed from and inserted into the respective first and second chambers; a lid movably mounted to close the open end and contain the first and second cores within the respective first and second chambers; at least one attachment to allow the lid to be moved between an open position to allow access to the first and second chambers and a closed position to contain the first and second cores within the respective first and second chambers; and a cartridge to mount the first and second cores as a unitary body for collective removal and insertion at the housing and to allow the cores to be extracted and separated from the apparatus.

Preferably, the cartridge is substantially planar. Optionally, the cartridge comprises a disc shaped configuration. Preferably, the lid is substantially planar. More preferably, the lid comprises a substantially disc shaped configuration. This is advantageous to minimise the overall size of the filtration device to allow convenient positioning within confined regions and to be accommodated as part of other components and devices with which the present filtration device is to form a component part. In particular, the substantially planar lid significantly reduces the overall height of the device which is desirable.

Preferably, the attachment comprises at least one hinge mechanism to allow the lid to be pivoted between the open and closed positions. Optionally, the attachment may comprise a sliding mechanism, a snap-click mechanism, a bayonet attachment, a screw thread arrangement provided at the lid and the rim of the housing or any other attachment mechanism to allow the lid to be moved between the open and closed position to allow convenient access to the internal chamber.

According to the preferred embodiment, the first and second cores are positionable in direct contact with fluid flowing within the respective first and second chambers. The cores may be surrounded by a protective sleeve or tubing that is removable with the cores as the cartridge is withdrawn from the internal chamber. Any such sleeves or tubing is therefore attached to the cartridge and represents part of the unitary cartridge body. However, and according to a specific implementation, the apparatus is devoid of tubes to surround the first and second cores mounted within the respective first and second chambers.

Preferably, the cartridge comprises at least one engaging portion to be grasped by a hand of an operator to remove and insert the cartridge and the first and second cores at the respective first and second chambers. The engaging portion may comprise an aperture, handle or other means to be grasped by the fingers and thumbs.

Preferably, the apparatus further comprises a mesh screen mounted within the second chamber. The mesh grade may be selected to achieve a desired filtration of non-ferrous particulates.

Preferably, the screen is removably mounted within the second chamber. This is advantageous to allow adjustment of the grade of mesh screen and to allow convenient cleaning of the mesh or removal from the internal chamber if this third filtration step is not required. Preferably, the screen is configured for positioning around the second core at a perimeter region of the second chamber.

Preferably, the apparatus comprises a plurality of magnetic cores positioned within the first chamber and a plurality of magnetic cores positioned within the second chamber and mounted at the cartridge. In particular, the apparatus comprises two initial magnetic cores positioned within the first chamber and four magnetic cores positioned within the second chamber. Preferably, the magnetic cores comprise sections of alternating north and south polarity magnets arranged as columns extending the axial length of the cores such that the alternating north and south polarity extends in a circumferential direction around the core centre. As will be appreciated, any magnetic configuration is compatible for use with the subject invention. For example, at least one of the magnetic cores may comprise sections of north or south polarity magnets distributed axially along the length of the magnetic core.

Optionally, the first and second chambers are defined by at least one partition wall extending internally within the housing. Optionally, the passageway is defined by a gap between an edge of the partition wall and a region or surface of the lid.

Preferably, the apparatus further comprises a seal to provide a fluid tight seal between the lid and housing when the lid is in the closed position.

Preferably, the first and second chambers are defined by at least one partition wall extending internally within the housing. Preferably, the passageway is defined by a gap in the partition wall separating the first and second chambers, the gap positioned towards each second end of the first and second chambers. Optionally, the first and second chambers and the passageway are sized such that a fluid flow speed in the first chamber is more than, and may be a multiple of (in particular at least double) the fluid flow speed in the second chamber. This is achieved as the cross sectional area (and volume) of the first chamber is less than the cross sectional area (and volume) of the second chamber. In particular the cross sectional area (and volume) of the first chamber is at least a quarter, a third, half , two thirds or three quarters less than the cross sectional area (and volume) of the second chamber.

According to a specific implementation when orientated in normal use the direction of the fluid flow passed the first magnetic core in the first chamber is opposed to gravity and the direction of the fluid flow in the second chamber passed the second magnetic core is in the same direction as the gravitational force.

### BRIEF DESCRIPTION OF DRAWINGS

A specific implementation of the present invention will now be described, by way of example only, and with reference to the accompanying drawings in which:

FIG. 1 is a perspective view of a magnetic filtration apparatus in which a plurality of elongate magnetic cores are positioned within a housing that is divided into a multi chamber vessel in which a movable lid allows opening and closing of the internal chambers;

FIG. 2 is a further perspective view of the apparatus of FIG. 1 with the cartridge of magnetic cores accommodated within the internal chambers;

FIG. 3 is a perspective view of the filtration apparatus of FIG. 2 with the section of the housing removed for illustrative purposes and illustrating a removable mesh insert;

FIG. 4 is a further perspective view of the entire housing assembly and mesh insert of FIG. 3;

FIG. 5 is a cross sectional side view of the filtration apparatus of FIG. 2 with the lid in the closed position;

FIG. 6 is an external perspective view of the filtration apparatus of FIG. 5.

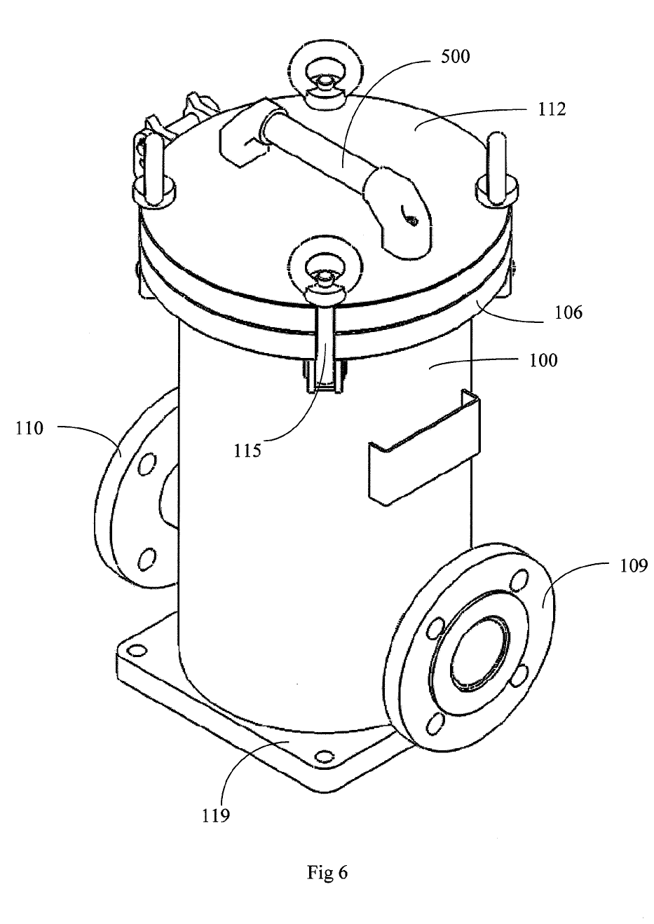

### DETAILED DESCRIPTION OF PREFERRED EMBODIMENT OF THE INVENTION

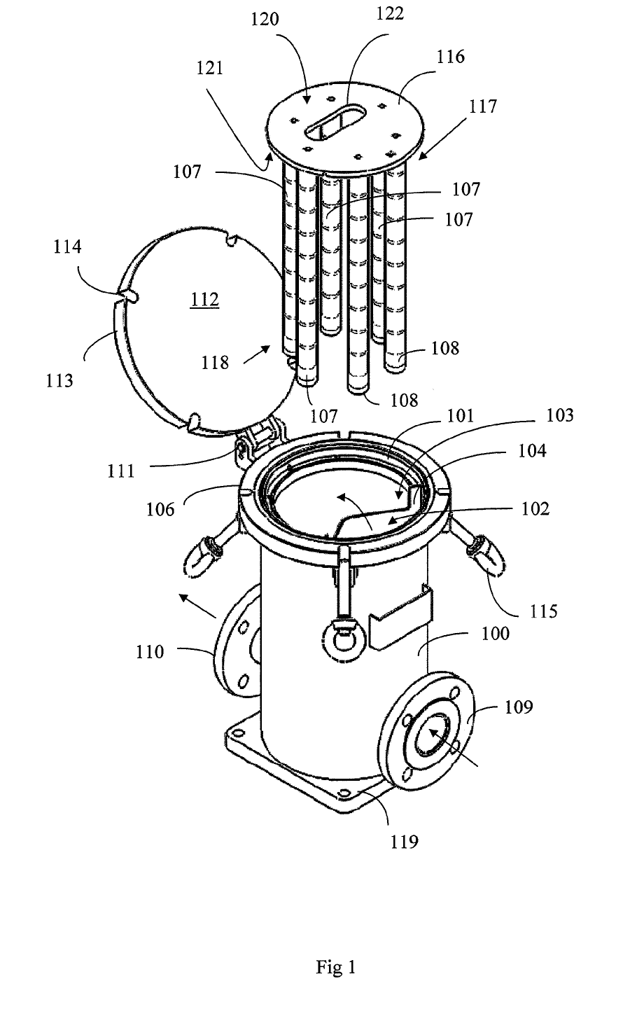

Referring to FIG. 1 the filtration apparatus comprises a housing 100 having an inlet 109 and an outlet 110. The housing 100, according to the specific implementation, is cylindrical with inlet 109 and outlet 110 positioned towards one end of the cylindrical wall in close proximity to a base 119.

The walls of the cylindrical housing 100 define an internal chamber 101 partitioned into a plurality of sub-chambers extending axially within the main chamber 101 along the length of the cylindrical housing 100. Internal chamber 101 is divided into a first internal chamber 102 and a second internal chamber 103 by elongate partition wall 104 extending longitudinally between the internal surface of the housing 100. An annular rim 106 is provided at an opposite end of housing 100 relative to base 119. Four pivotally mounted locking lugs 115 project radially from a lower region of rim 106. A disc-like lid 112 is also attached to rim 106 via a hinge mechanism 111 to allow lid 112 to pivot about hinge 111 between an open position (as illustrated in FIG. 1) and a closed position in contact with rim 106 to close the open end of internal chamber 101. In the closed position, lid 112 may be locked in position by pivoting lugs 115 into an ‘upright’ configuration such that endmost regions of the lugs 115 engage into notches 114 indented into a perimeter 113 of lid 112.

A plurality of elongate magnetic cores 107, 108 comprise respective first ends 117 and respective second ends 118. Cores 107, 108 are mounted at their first ends 117 at a common cartridge 116 in a form of disc-like body. In particular, cores 107, 108 are attached at ends 117 to an underside face 121 of disc 116 such that an upper face 120 is configured for positioning against the underside face of lid 112 when lid 112 is moved to the closed position to lock the cartridge assembly 116, 107, 108 within internal chamber 101. An aperture 122 is provided through the cartridge disc 117 to allow a user to grasp disc 116 and extract the cartridge assembly 116, 107, 108 from internal chamber 101 when lid 112 is moved to the open position is illustrated in FIG. 1.

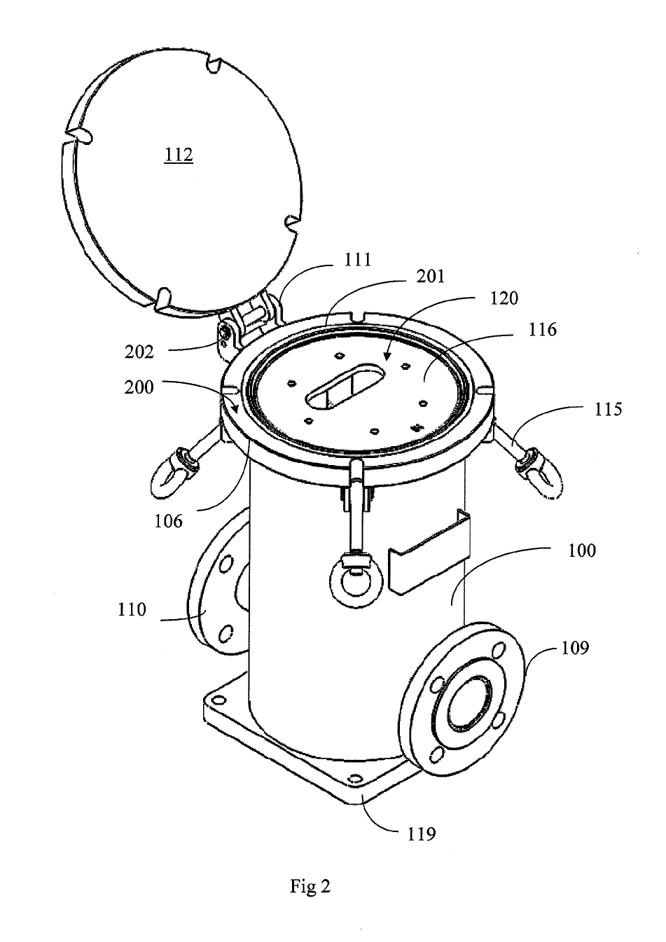

Referring to FIG. 2, cartridge assembly 116, 107, 108 is configured to be loaded and entirely accommodated within internal chamber 101 such that an uppermost annular face 200 of rim 106 is aligned approximately coplanar with cartridge upper face 120. One or a plurality of O-ring sealing gaskets 201 are provided at an internal region of rim 106 to provide a fluid tight seal when lid 112 is moved into the closed position in contact with uppermost annular face 200 and cartridge face 120. Lid 112 is conveniently moved between the open and close positions via rotation about a pivot pin 202 forming an integral part of hinge 111. Partition wall 104 is positioned such that the volume of the first chamber 102 is less than the volume of second chamber 103. In particular, the volume (and cross section area in a plane parallel to base 119) of first chamber 102 is less than half that of second chamber 103 and in particular one quarter of the volume (and cross section area) of the second chamber 103 according to the specific implementation.

A pair of rod-like elongate magnetic cores 108 is positionable within first chamber 102 and is capable of extending axially substantially the full length of cylindrical housing 100 within internal chamber 101. Similarly, four elongate rod-like magnetic cores 107 are positionable within the second chamber 102 to extend axially along the length of cylindrical housing 100 within main internal chamber 101. That is, the second ends 118 of cores 107, 108 are positioned substantially at base 119 whilst first core ends 117 are positioned approximately at rim 106.

As illustrated in FIG. 1, partition 104 is specifically configured to extend axially within internal chamber 101 between base 119 and rim 106 to partition internal chamber 101 into the sub-chambers 102, 103 whilst providing a ‘gap region’ for the through-flow of fluid from the first chamber 102 into the second chamber 103. Accordingly, fluid is capable of flowing from inlet 109 through internal sub-chambers 102, 103 and to exit the device via outlet 110.

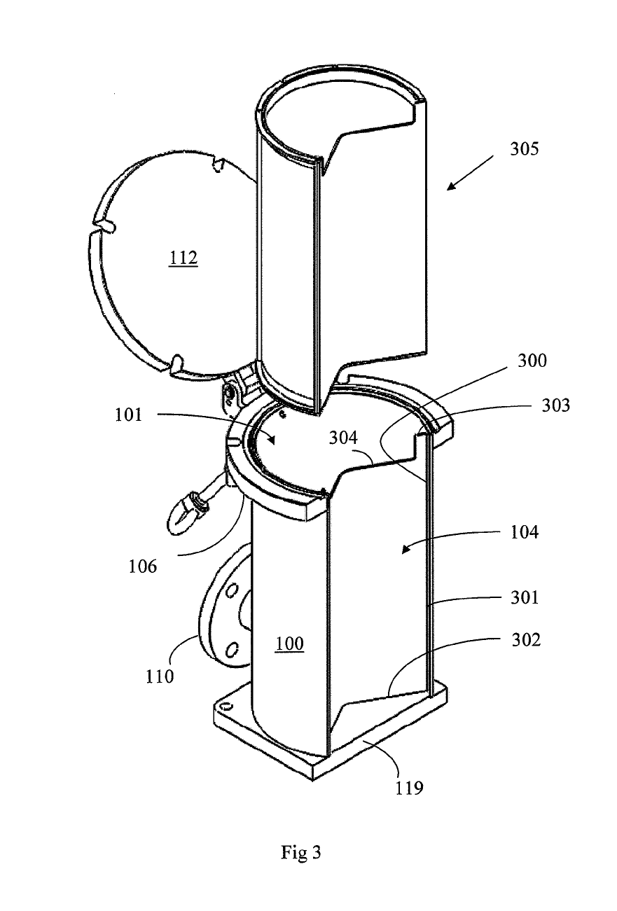

Referring to FIG. 3, partition wall 104 is formed from a single piece of rigid material having lengthwise edges 301 and widthwise edges 302, 303, 304. Edge 302 is intended to be positioned lowermost within internal chamber 101 in contact with base 119 whilst upper edges 303, 304 are positioned axially at or towards rim 106. Partition 104 is substantially planar but is formed in a bent or folded configuration with the fold extending axially parallel to lengthwise edges 301 and is positioned approximately at a mid-width region of edges 302, 304.

Lengthwise edges 301 are positioned in contact with inward facing surface 300 of housing 100 that defines internal chamber 101. A groove is formed within partition 104 at its uppermost region to be indented from uppermost edge 303. Groove defines a notch or partial ‘cut-out’ section at the uppermost region of partition 104 such that edge 304 is positioned axially lower than uppermost partition edge 303 that is aligned approximately coplanar with rim face 200. Accordingly, fluid is capable of flowing over partition 104 and over edge 304 when lid 112 is positioned in the closed position to seal internal chamber 101.

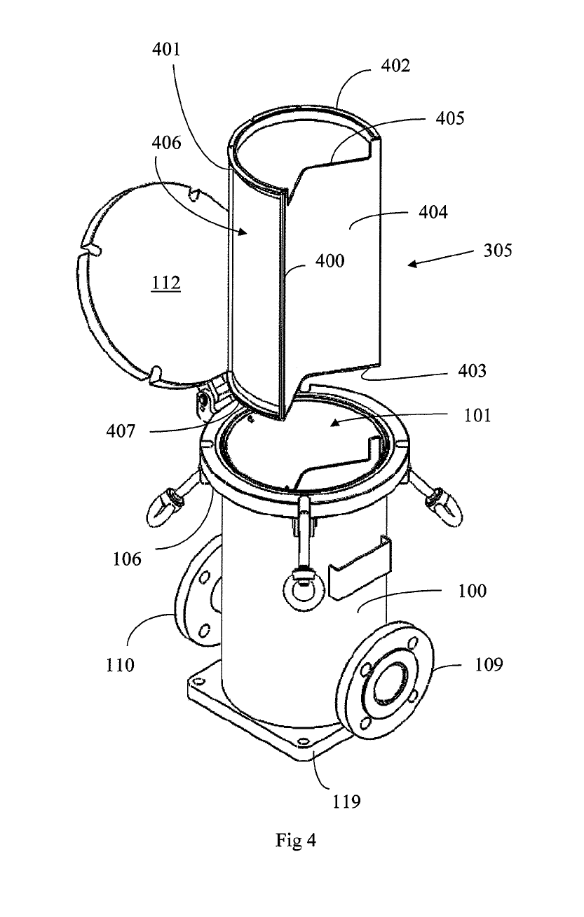

Referring to FIGS. 3 and 4, the filtration apparatus further comprises an insert 305 configured for positioning and accommodation within second chamber 103. Insert 305 comprises generally a mesh construct and is shaped and dimensioned to closely resemble the shape and dimensions of second internal chamber 103 as defined by partition 104 and housing internal surface 300. In particular, insert 305 comprises a part cylindrical section 401 that interfaces with an angular sidewall 404 having a shape and configuration to closely resemble the shape and configuration of partition 104. That is, sidewall 404 comprises a lower edge 403 for positioning at partition edge 302 and an upper edge 405 for positioning at partition upper edge 304. Additionally, a part annular uppermost rim 402 of the mesh insert 305 is positionable at the annular rim 106 of housing 100. Insert 305 comprises a rigid frame 400 that extends axially and lengthwise along the side edges of sidewall 404 and along the part circular upper and lower rims 402, 407. The region between edges 403, 405 is formed from a non-mesh solid material whilst the part cylindrical body region 406 extending between curved rims 402, 407 comprises a mesh material. With insert 305 inserted within chamber 103, outlet 110 is internally obscured by a part of mesh 406. Accordingly, as fluid flows through internal chamber 103 it is forced to flow through mesh 406 as it exists the apparatus via outlet 110.

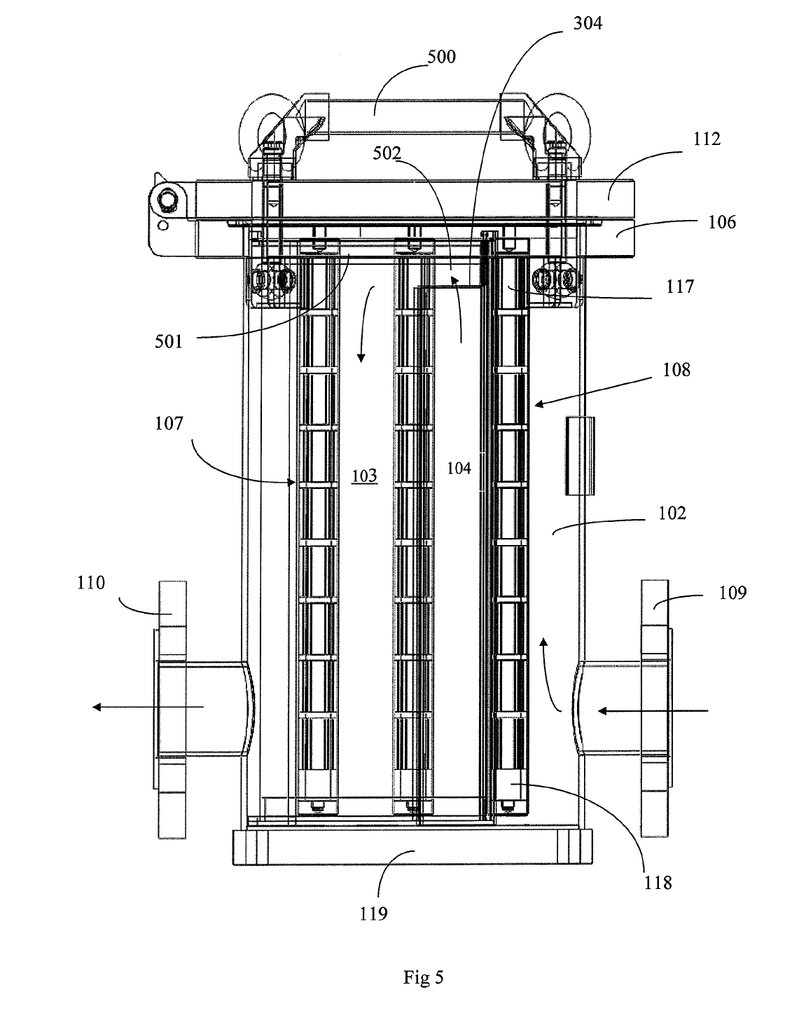

Referring to FIG. 5, with the cartridge assembly 116, 107, 108 loaded and accommodated within internal chamber 101, fluid is capable of flowing through inlet 109 axially along the length of first chamber 102 and through a gap 502 defined by the axially uppermost partition edge 304 and an internal facing surface 501 of lid 112. The fluid then flows in the axially downward direction through second chamber 103 to exit the apparatus outlet 110. The fluid flow through first chamber 102 occurs in an upward direction against gravity in contrast to the axial flow path through second chamber 103 (with gravity).

As indicated, fluid communication between the first chamber 102 and second chamber 103 is provided by the small gap between the uppermost edge 304 of partition wall 104 and the downward facing surface 121 of a lid 112 that seals the upper end of internal chamber 101.

That is, internal partition wall 104 extends from base 119 to a region just below lid 112 such that fluid is capable of flowing over the upper edge 304 of the partition 104. As the fluid flows passed the elongate magnetic cores 108, the magnetic field created by the cores acts to entrap the ferrous contaminant material around each core 108 as a pre-filtration step.

The pre-filtered fluid then flows into second chamber 103 and in a downward direction passed the magnetic cores 107. Further contaminant material, not entrapped by magnetic cores 108, is then captured by the second filtration step as the fluid flows through the magnetic field generated by the magnetic cores 107. As a third stage filtration, any non-magnetically susceptible particulate contaminant is then filtered via mesh 406 to retain this particulate within the insert 305 and the second chamber 103.

In order to optimise filtration the fluid is directed to flow in the upward direction against gravity within first chamber 102 and a second opposed direction with the gravitational force along the length of chamber 103. By configuration of the relative dimensions and positioning of international partition wall 104, the fluid flow speed through first chamber 102 is at least double that of the flow rate through second chamber 103. Furthermore, filtration is maximised by increasing the exposure of the working fluid to the magnetic field created by the magnetic cores 108, 107 by directing the fluid to flow axially along the cores 108, 107 in at least two directions.

The present apparatus is advantageous as the outer surfaces of the magnetic cores 107, 108, are positioned in direct contact with the fluid as it flows through chambers 102, 103. That is, the present apparatus is devoid of elongate hollow tubes of existing filtration devices that accommodate the elongate magnetic cores 108, 107 and effectively partition and isolate the cores from contact with the working fluid. The present configuration provides that any magnetically susceptible material is entrapped by the magnetic cores and is therefore removable from the internal chamber 101 as the cartridge assembly 116, 107, 108 is removed when lid 112 is moved to the open position as shown in FIG. 1 via a user grasping a handle 500 mounted on an external facing side of lid 112. The cartridge 116, 107, 108 may then be cleaned to remove the deposited particulate contaminant or a replacement cartridge inserted. The present apparatus is beneficial to allow interchange of cartridges 116, 107, 108 of different magnetic core configurations. For example, cartridge 116 may comprise a different number of rod-like magnetic cores 107, 108 and magnetic cores of different magnetic strength to allow adjustment of the magnetic field circuit strength, shape and configuration to adjust the filtration performance of the apparatus. The present filtration device is therefore not compatible with automated mechanisms to remove and insert the filtration rods 107, 108 within internal chamber 101 as the present core interchange/cleaning process is adapted to be manual.

1. Magnetic filtration apparatus to separate contaminant material from a fluid, said apparatus comprising:
a housing to provide containment of a fluid flowing through the apparatus, the housing having a fluid inlet and a fluid outlet;
a first elongate chamber within the housing, the first chamber in fluid communication with the inlet substantially towards a first end to allow fluid to enter the first chamber;
a first elongate magnetic core extending axially within the first elongate chamber such that a magnetic field generated by the first magnetic core is created in the fluid flow path to entrap contaminant material as it flows passed the first magnetic core;
a second elongate chamber the housing, the second chamber in fluid communication with the outlet substantially towards a first end to allow the fluid to exit the second chamber, wherein the volume of the first chamber is less than the volume of the second chamber such that a fluid flow speed in the first chamber is greater than a fluid flow speed in the second chamber;
a second elongate magnetic core extending axially within the second elongate chamber such that a magnetic field generated by the second magnetic core is created in the fluid flow path to entrap contaminant material as it flows passed the second magnetic core;
a passageway connecting the first and second elongate chambers in internal fluid communication towards their respective second ends such that the fluid is directed to flow from the inlet passed substantially the full length of the first magnetic core in a first direction, through the passageway, passed substantially the full length of the second magnetic core in a second direction opposed to the first direction to the outlet;
wherein the housing comprises an open end to allow the first and second cores to be removed from and inserted into the respective first and second chambers;
a lid movably mounted to close the open end and contain the first and second cores within the respective first and second chambers;
at least one attachment to allow the lid be moved between an open position to allow access to the first and second chambers and a closed position to contain the first and second cores within the respective first and second chambers; and
a cartridge to mount the first and second cores as a unitary body for collective removal and insertion at the housing and to allow the cores to be extracted and separated from the apparatus.

2. The apparatus as claimed in claim 1 wherein the cartridge is substantially planar.

3. The apparatus as claimed in claim 1 wherein the cartridge comprises a disc shaped configuration.

4. The apparatus as claimed in claim 1 wherein the lid is substantially planar.

5. The apparatus as claimed in claim 1 wherein the lid comprises a substantially disc shaped configuration.

6. The apparatus as claimed in claim 1 wherein the attachment comprises at least one hinge mechanism to allow the lid to be pivoted between the open and closed positions.

7. The apparatus as claimed in claim 1 wherein the first and second cores are positionable in direct contact with fluid flowing within the respective first and second chambers.

8. The apparatus as claimed in claim 1 wherein the apparatus is devoid of tubes to surround the first and second cores mounted within the respective first and second chambers.

9. The apparatus as claimed in 1 wherein the cartridge comprises at least one engaging portion to be grasped by a hand of an operator to remove and insert the cartridge and the first and second cores at the respective first and second chambers.

10. The apparatus as claimed in further comprising a mesh screen mounted within the second chamber.

11. The apparatus as claimed in claim 10 wherein the screen is removably mounted within the second chamber.

12. The apparatus as claimed in claim 10 wherein the screen is configured for positioning around the second core at a perimeter region of the second chamber.

13. The apparatus as claimed in 1 comprising a plurality of magnetic cores positioned within the first chamber and a plurality of magnetic cores positioned within the second chamber and mounted at the cartridge.

14. The apparatus as claimed in claim 1 wherein the first and second chambers are defined by at least one partition wall extending internally within the housing.

15. The apparatus as claimed in claim 14 wherein the passageway is defined by a gap between an edge of the partition wall and a region or surface of the lid.

16. The apparatus as claimed in claim 1 further comprising a seal to provide a fluid tight seal between the lid and housing when the lid is in the closed position.
